(19) United States
(12) Patent Application Publication
(10) Pub. No.: US 2013/0007028 A1
(43) Pub. Date: Jan. 3, 2013

(54) DISCOVERING RELATED FILES AND PROVIDING DIFFERENTIATING INFORMATION

(75) Inventors: Christopher S. Alkov, Austin, TX (US); Travis M. Grigsby, Austin, TX (US); Andrew J. Ivory, Wake Forest, NC (US); Trevor Livingston, Austin, TX (US)

(73) Assignee: INTERNATIONAL BUSINESS MACHINES CORPORATION, Armonk, NY (US)

(21) Appl. No.: 13/171,449

(22) Filed: Jun. 29, 2011

(51) Int. Cl. G06F 7/00

(52) U.S. Cl. 707/758; 707/E17.001

(57) ABSTRACT

Related files are discovered, and the discovered information is provided for a user. Informative annotations and/or information that differentiates among the discovered files may also be provided. In one aspect, user-provided criteria are used to determine whether files are related. Examples include: same (or similar) file name; modified near in time to one another; use of similarity hashing; similar file size; and event(s) performed on the files.

### CROSS-REFERENCE TO RELATED APPLICATION

The present invention is related to commonly-assigned and co-pending application Ser. No. ______, which is titled “Tracking File-Centric Events” (Attorney Docket RSW920110065US1). This application, which is referred to hereinafter as “the related application”, was filed on even date herewith and is incorporated herein by reference.

### BACKGROUND

The present invention relates to computing systems, and deals more particularly with techniques for discovering related files and providing the discovered information. Information that differentiates among the discovered files may also be provided.

A user of a computing device (such as a laptop computer, desktop computer, handheld computer, etc.) may have a very large number of files stored on the computing device or accessible thereto. Managing these files can therefore be problematic.

### BRIEF SUMMARY

The present invention is directed to discovering related files and providing a view thereof. In one aspect, this comprises: receiving an identification of a selected file; receiving an identification of user-selected criteria for determining relatedness; discovering at least one file that is related to the selected file according to the identified criteria; and providing an identification of each of the discovered at least one file. The criteria may be based on (by way of example) at least one of: file name of the selected file; modification time of the selected file; file size of the selected file; a value computed by performing a similarity hash on contents of the selected file; and at least one event that pertains to the selected file.

Embodiments of these and other aspects of the present invention may be provided as methods, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

### BRIEF DESCRIPTION OF THE SEVERAL VIEWS OF THE DRAWINGS

The present invention will be described with reference to the following drawings, in which like reference numbers denote the same element throughout.

FIG. 1 illustrates a scenario where multiple versions of a particular file are stored on, or accessible to, a user's computing device;

FIG. 2 (comprising FIGS. 2A-2D) illustrates how a view of related files may be provided by an embodiment of the present invention;

FIG. 3 (comprising FIGS. 3A-3B) provides flowcharts depicting logic which may be used when implementing an embodiment of the present invention;

FIG. 4 illustrates a sample view from which a user may configure operation of an embodiment of the present invention;

FIG. 5 depicts a data processing system suitable for storing and/or executing program code; and

FIG. 6 depicts a representative networking environment in which one or more embodiments of the present invention may be used.

### DETAILED DESCRIPTION

A user of a computing device may have a very large number of files stored on the computing device or accessible thereto. Some of these files are related to each other. It may happen that a user needs to find a related file or files. An embodiment of the present invention discovers related files, and provides the discovered information. Informative annotations and/or information that differentiates among the discovered files may also be provided. In preferred embodiments, discovered information is provided to a user on a graphical interface.

Files may be related to each other according to different criteria. In one example, a user may have many versions (also referred to herein as “copies”) of a particular file, and the versions may therefore be considered as related to one another. As another example of file relatedness, it may be useful to consider files that were opened, closed, or modified at the same time—or at nearly the same time—as being related to one another. As yet another example of file relatedness, it may be useful to consider files having similar content as being related. These examples are by way of illustration but not of limitation, and relatedness may be determined using other criteria without deviating from the scope of the present invention. Several sample scenarios will now be discussed.

Referring again to the scenario where file relatedness is in terms of different versions of a particular file, the versions may be spread over different storage areas of the user's computing device and/or stored in locations that are separate from the computing device but linked to it by network connections or physical connections. It may be difficult for the user to easily or conveniently distinguish, at a glance, which one of these versions is desired at a point in time. Suppose a particular user Allen is looking for a presentation to use in an upcoming meeting. Allen may recall that he has a copy of the presentation in a downloads folder of his e-mail system, and that he received this copy from some co-worker, although he can't recall which co-worker sent the copy or when it was received. It may be infeasible for Allen to try to search through the messages of his e-mail system in an effort to try to locate this copy. Allen may also have a copy stored in a directory of a file system on his computing device—and might not remember which directory—and multiple copies stored may also be stored in a shared storage system that is remote from his computing device.

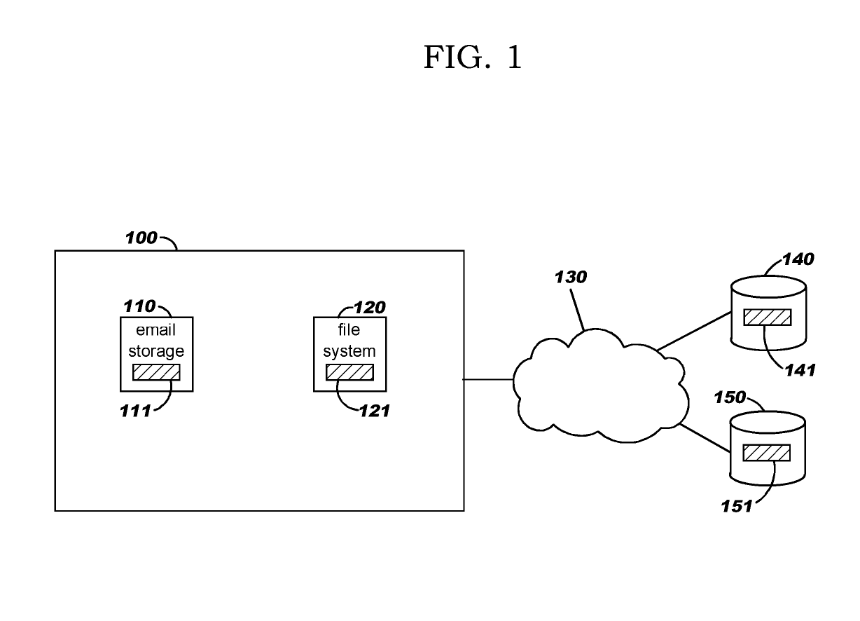

This scenario is illustrated by FIG. 1. As shown therein, Allen's computer 100 contains e-mail storage 110 and, in this example, a separate file system storage 120. The first copy of the presentation stored in the downloads folder is depicted at 111, and the second copy stored in a directory of the file system is depicted at 121. FIG. 1 illustrates two additional copies 141, 151 of the presentation which are stored remotely in shared storage systems 140, 150 which are accessible from Allen's computer 100 using a connection through a network 130.

Because all of these different versions may have been created over a long time period, Allen may forget how many copies of the file he has, where they are located, and/or what—if any—differences there are between the copies. Using existing techniques, if Allen is looking for a particular version of the file, he will need to either open each copy and check its contents, or alternatively look at the file properties for each copy in order to see the date/time at which the copy was updated. Once this information is known for each of the copies, Allen then has to make a comparison among the information he obtained in order to determine which copy is the one he wants to use. As will be obvious, this manual determination is tedious and error-prone.

As an example of a scenario where file relatedness is in terms of the time at which files are opened, closed, or modified, it may happen that the user is reviewing one or more stored documents and is entering a summary of the reviewed information into a separate document. Or, the user may be simultaneously working with several files for other reasons. Manually determining that these files are related may be difficult for a user, particularly if they are not stored in a common storage area.

As an example of a scenario where file relatedness is in terms of file content, suppose a user has a copy of an image in “JPEG” format and a copy of the same image in “TIFF” format. Or, the user might have a stored copy of a song in a “WAV” file format, and might also have a stored copy of a movie in “MPEG” format, where the movie contains the song. As yet another example, the user might have a stored copy of a song that uses “MP3” format, and another stored copy of the same song that uses “AIC” format. (Details of differences among these various file formats are not material to an understanding of the present invention, and such details are therefore not provided herein.) In these various examples, manually determining that the files are related may be difficult for a user, as the actual binary file contents may be quite different while still representing the same information (e.g., the same song).

An embodiment of the present invention uses file content and/or metadata to determine which files are related to one another. A file indexing service may be provided by an operating system, building an index on file content and/or metadata, and such file indexing service may be leveraged by an embodiment of the present invention to find related files. Once the related files have been found, a representation thereof is preferably presented to the user on a graphical user interface. (While discussions herein focus on a visual display, this is by way of illustration and not of limitation.)

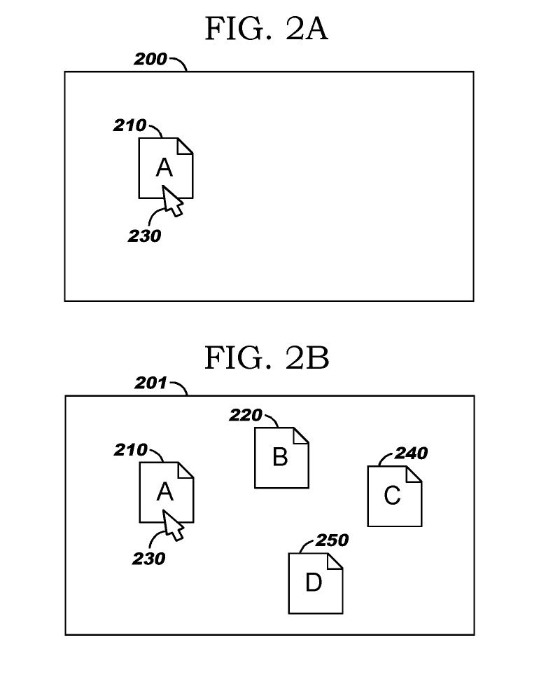

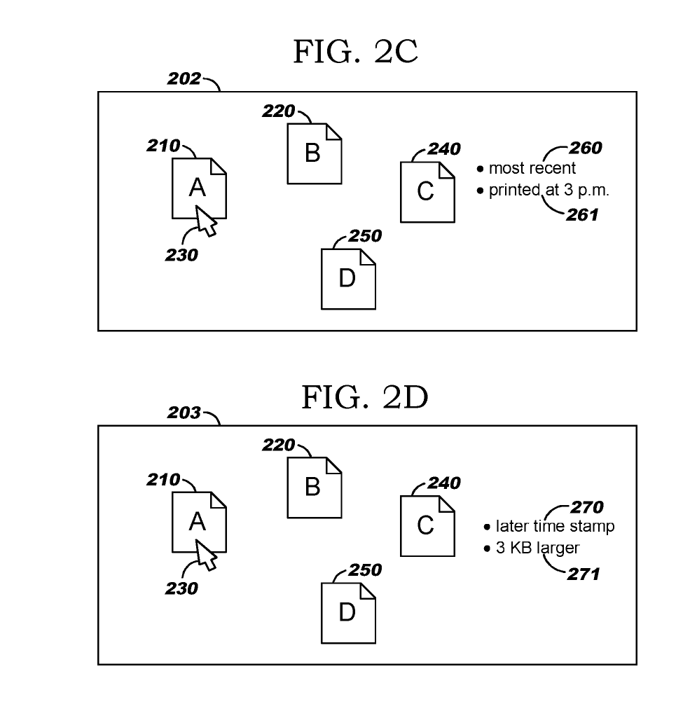

FIGS. 2A-2B illustrate one way in which related files may be depicted for a user. In this example, an icon 210 corresponding to a particular file is initially displayed in a view 200, as shown in FIG. 2A. For ease of discussion, this icon is labelled “A” in the figures to refer to a corresponding file “A”. Responsive to a user gesture such as moving a mouse cursor 230 over the icon 210 and requesting to find related files for file “A”, an embodiment of the present invention finds the related files and displays icons corresponding thereto. A sample user interface view 201 showing resulting information is depicted in FIG. 2B. In this example, 3 icons are represented, as shown at 220, 240, 250. For ease of discussion, these icons are labelled in FIG. 2B as “B”, “C”, and “D”, respectively to refer to the corresponding files.

Suppose, by way of example, that Allen was viewing entries in his e-mail downloads folder, and found the e-mail where his co-worker sent the previously-discussed presentation to him. Icon 210 in FIG. 2A corresponds to a representation “A” of this downloaded presentation within the e-mail system. With reference to the illustration in FIG. 1, an embodiment of the present invention may have discovered a second copy “B” 121 of the presentation stored in file system 120, a third copy “C” 141 which is stored in a remote shared storage system 140, and a fourth copy “D” 151 which is stored in a different remote shared storage system 150. Accordingly, these discovered results “B” through “D” are illustrated by displaying icons 220, 240, 250 in FIG. 2B.

FIG. 2C illustrates sample annotations that may be provided for the user who is viewing the related files discovered using an embodiment of the present invention. As shown in this example at 260, a first annotation indicates that icon 240 corresponds to the most-recent one “C” of the 4 copies of the presentation which Allen is looking for, and at 261, a second annotation indicates that this file “C” was recently printed at 3 p.m. Reference number 261 represents an optional aspect of the present invention, whereby file event information is gathered for each file (when available) and provided in the resulting view. An annotation may also be provided for one or more of the copies to specify the location where that copy is stored, although this has not been illustrated in FIG. 2. Annotations may also be provided for one or more of the other icons 210, 220, 250, although this has not been illustrated in FIG. 2C.

FIG. 2D illustrates sample difference information which may be provided for the user who is viewing the related files which have been discovered using an embodiment of the present invention. As shown in this example at 270, a first difference for the file “C” corresponding to icon 240—as compared to the file “A” corresponding to icon 210, which was selected by the user—is that file “C” has a later timestamp than file “A”, and a second difference 271 for file “C” is that file “C” is 3 Kilobytes larger than file “A”. Differences may also be provided for one or more of the other icons 220, 250, although this has not been illustrated in FIG. 2D.

While several annotations and differences are illustrated in FIGS. 2C-2D, these are by way of example only. Other illustrative examples include displaying (as an annotation and/or a difference): file name or extension; file size; metadata information; events performed on the file; an illustrative snippet from the file; a link to where further details are viewable; and so forth.

While a sample layout is illustrated in FIGS. 2B-2D, any of a number of alternative layouts for presenting the related file information may be used without deviating from the scope of the present invention. In one alternative, a radial layout may be used where the initially-displayed icon 210 has a certain size and placement in the view, and the icons that represent the located copies have a somewhat smaller size and are placed in the view at generally equal distances from the initially-displayed icon. In another alternative, an evaluation of a degree of relatedness may be computed for each related file, and the corresponding icons may then be arranged to reflect the degree of relatedness. For example, if relatedness is determined in view of a time at which file modifications occurred, the icons 220, 240, 250 may be displaced from icon 210 in a time-ordered sequence. That is, the icon for which the corresponding file was modified closest in time to the file represented by icon 210 may be located closest to icon 210. As yet another alternative, if relatedness is determined in view of similarity of file content, the icon for the file which is most similar to the file represented by icon 210 may be located close to icon 210, and so forth. An embodiment of the present invention may also simply display the related icons in a tiled, cascaded, or other alignment, without regard to comparisons among the files.

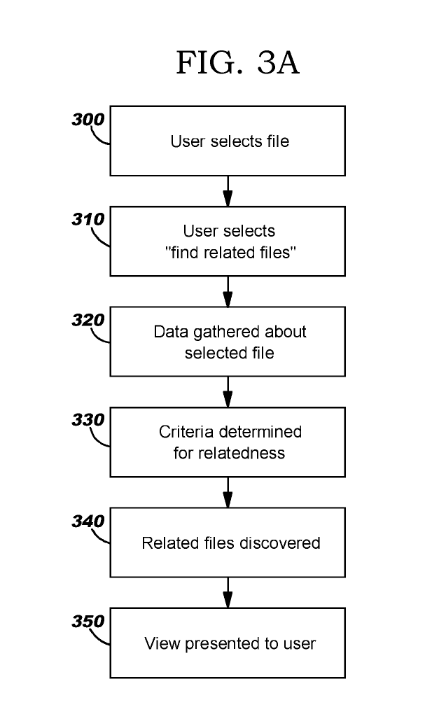

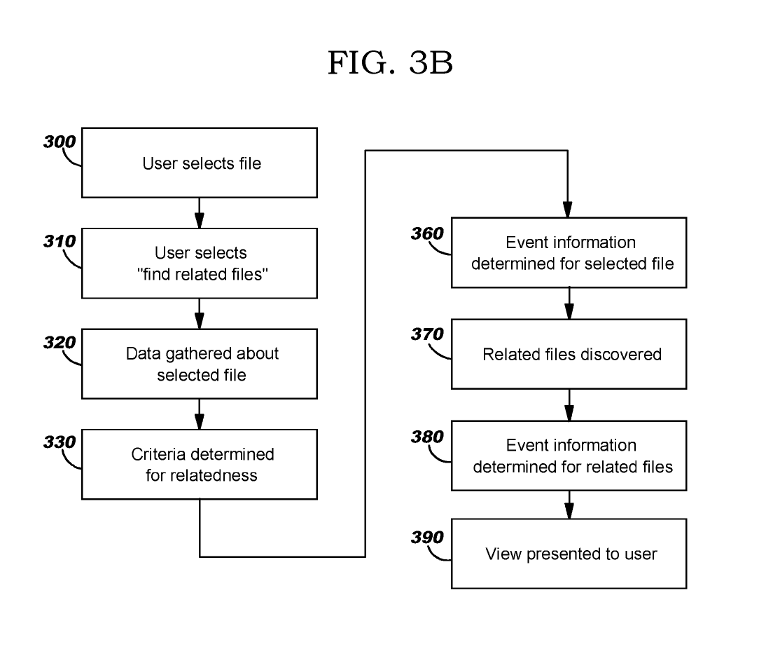

Turning now to FIGS. 3A-3B, flowcharts are depicted showing logic which may be used when implementing an embodiment of the present invention, as will now be discussed.

FIG. 3A depicts logic which may be used when implementing an embodiment of the present invention, and begins at Block 300 with the user selecting a representation of a particular file. With reference to the scenario discussed above, this corresponds to Allen selecting icon 210 of FIG. 2A. At Block 310, the user requests to find files that are related to the file selected at Block 300. This request at Block 310 may be initiated using, by way of example, a right-click action with a mouse, selection of a choice from a pop-up or pull-down menu, and so forth, and the actual request mechanism may vary without deviating from the scope of the present invention.

At Block 320, data is gathered about the file selected at Block 300. This data may comprise, by way of illustration but not of limitation, the file name, modification time, file size, and/or a value computed by performing a similarity hash on the file contents. Algorithms for performing a similarity hash are known in the art, and are therefore not described in detail herein. One example is the so-called “pHash”, which refers to an open source software library that implements several perceptual hashing algorithms (for example, to compare files in view of copyright protection, similarity searching for media files, or perhaps for digital forensics).

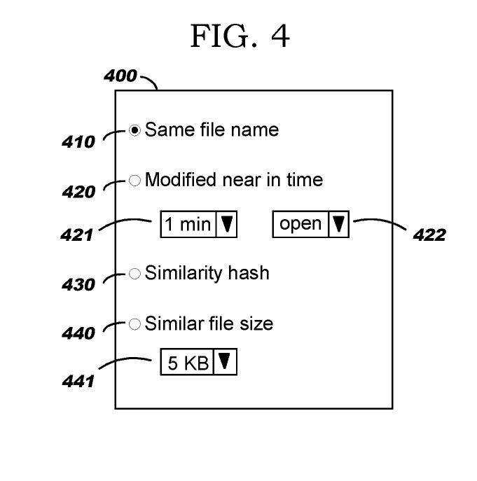

Block 330 determines which criteria will be used to determine relatedness. In one aspect of the present invention, a single manner of determining relatedness is supported by the implementation, in which case the processing of Block 330 may be omitted. In another aspect, a user may be allowed to configure the implementation to use a user-preferred or file-specific manner of determining relatedness. In this latter case, an implementation may be constructed to offer several predetermined alternatives, and may present these alternatives to the user on a configuration view, as discussed below with reference to FIG. 4. As yet another approach, the user may be allowed to enter (or otherwise identify, such as by selection with a browse function) a path name that identifies a location of executable code that will be used to determine relatedness.

FIG. 4 illustrates an example view 400 for providing predetermined alternatives that allow a user to configure how relatedness will be determined. As shown in this example, choices are provided with radio buttons for user selection among the alternatives. The choices shown in FIG. 4 will now be discussed.

Choice 410 indicates that relatedness is to be determined based on the name of the file. In one approach, this may comprise discovering multiple versions of a file having the same file name, as discussed above with reference to FIG. 1. In another aspect, an option might be provided whereby the user can indicate that the file names need to be similar, but not identical, although this has not been illustrated. For example, files may be considered related if they begin with the same name but have a digit appended to the end in order to allow multiple versions to co-exist with a particular storage system. As another example, an option for wildcard matching might be provided.

Choice 420 provides for relatedness to be determined based on files that are modified near in time to one another. Additional options are depicted in this example, where a first drop-down menu 421 allows the user to specify a time interval for this matching and a second drop-down menu 422 allows the user to restrict the matching to a particular type of file modification. In the example of FIG. 4, a selectable time interval is shown as “1 min” (i.e., 1 minute), and a selectable type of file modification is shown as “open”.

Choice 430 provides for relatedness to be determined using a similarity hash. In one approach, a predetermined similarity hash algorithm is used when this choice 430 is selected. In another approach (not shown), a text entry box or browse window may be provided in which the user can identify a location of the executable code of the algorithm. This may be advantageous for supporting media-specific comparisons, whereby executable code can determine (for example) whether a file in MP3 format is related to a file in AIC format, as was discussed earlier.

Similar file size is another criteria that might be used to determine relatedness, as shown by choice 440. In one approach, a predetermined difference in file size is used as a threshold. In another approach, which is shown in FIG. 4, a drop-down menu 441 allows the user to select a tolerance value, which in this example is illustrated as 5 Kilobytes.

While several choices have been illustrated on the configuration view 400 in FIG. 4, an embodiment of the present invention may provide additional or different choices without deviating from the scope of the present invention. Examples include, but are not limited to, using tags and/or tag values that are associated with files encoded in a markup language; using metadata associated with files; and so forth. A user might want to find all files containing a tag such as “<accountNumber>”, for example. The metadata may comprise, by way of example, spotlight comments which are associated with files, project identifiers which are associated with files, and user-created categories which are associated with files.

Returning now to the discussion of FIG. 3A, Block 340 searches for related files, in view of the file selected at Block 300 and the relatedness criteria as determined at Block 330. This may comprise accessing a file index that is built by a file indexing service from file content and/or metadata, as noted earlier. When file relatedness is determined using file names, file modification time, or file size, for example, an embodiment of the present invention may populate a search facility provided by the operating system with the corresponding information for the file selected at Block 300, and results of this search are then returned for use by the embodiment of the present invention.

It may happen that performance issues occur with some types of relatedness determinations. As an example, it may be desirable in some scenarios to perform a binary scan on file contents to determine relatedness, and this may require processor-intensive comparisons. Accordingly, an embodiment of the present invention may be adapted for placing limitations on the scope of the relatedness comparison, and/or for allowing a user to place such limits. If the user requests to determine relatedness by a processor-intensive scan, for example, negative performance effects thereof may be countered by restricting the scope of the search to files in a particular directory or directories, to files having particular file extensions, and so forth. FIG. 1 illustrated a scenario where related files were discovered on remotely-located storage systems. An embodiment of the present invention may be adapted for searching only on the local system, and/or for allowing a user to select such restriction. A configuration view such as view 400 may be used to allow a user to specify these types of limitations.

In addition to searching local e-mail storage and file system storage and remotely-located shared storage systems, as has been discussed, an embodiment of the present invention may support other types of searching. Examples include, but are not limited to, searching synchronized devices and accounts; mobile devices; multiple e-mail accounts, including e-mail messages and/or attachments; content at locations which are bookmarked for a browser; files in databases; archived files; files created by particular applications; and so forth. A configuration view such as view 400 may be used to allow a user to specify where to search, and what to search for there. For example, the user might specify several e-mail accounts to be searched, or several databases to search, and so forth. Particular applications may provide an application-specific way to search files created by that application, and an embodiment of the present invention may be adapted for using application-specific code for searching.

After discovering the related files at Block 340, Block 350 presents a view of those discovered files. Annotations may be included in the view, and may comprise information about the user-selected file, one or more discovered files, differences among the files, and so forth, as has been discussed above with reference to the sample views in FIG. 2. The processing of FIG. 3A is then complete for this iteration.

FIG. 3B depicts logic which may be used when implementing an alternative embodiment of the present invention. The processing in Blocks 300-330 is preferably analogous to that which has been discussed for FIG. 3A, after which control reaches Block 360.

In Block 360, event information is determined for the file that was selected by the user at Block 300. This event information may comprise, by way of example, determining that the file has recently been sent to another user by e-mail; determining that a photo stored in a file has been cropped (or otherwise altered); determining that the file was recently opened in a browser; and so forth. Preferably, an embodiment of the related application is leveraged for obtaining such event information. In one approach, event information may be limited to recent events, and the user may be allowed to specify a time frame for use in this determination.

One way in which event information may be obtained is by inspecting logs created by applications. A log might record that a particular file was changed on a certain date at a certain time, with descriptive information about the change, for example. Other applications store information about changes within the file itself. Application-specific code may therefore be used to obtain event information from such files.

Processing then reaches Block 370, which discovers related files. This may proceed in an identical manner to that which has been described above for Block 340 of FIG. 3A, in cases where the event information obtained at Block 360 will be used simply as an informative annotation provided to the user. Reference number 261 in FIG. 2B, which was discussed above, denotes one example of this type of informative annotation. Alternatively, the processing of Block 370 may comprise using the event information obtained at Block 360 in combination with other information (e.g., the user-selected file from Block 300 and the criteria determined at Block 330) to determine file relatedness. For example, a user might want to know which files are related by virtue of having been sent together as attachments to an e-mail message, or which files are related by having been created or processed with the same application. Accordingly, a configuration view such as view 400 of FIG. 4 may be adapted for allowing the user to select one or more event types (such as “sent together as e-mail attachment”) for use in determining whether files are related.

As related files are discovered, event information for those files is gathered, as indicated at Block 380. Processing then continues at Block 390, where a view of the discovered files is presented. Event-related annotations and/or differences may be included in the view. One example of an event-related annotation is shown at 261 in FIG. 2B, by way of illustration, to denote an event that was performed on the file to which an annotation corresponds. The processing of FIG. 3B is then complete for this iteration.

Event-related differences may be determined by consulting event logs, by inspecting event-related information stored within discovered files, and so forth. As one example, it may be determined that file “A” 210 was e-mailed from Allen's computing device, while file “B” 220 was not. As another example, it might be determined that file “C” 240 was created responsive to passing file “B” 220 as a parameter on an invocation of a file-storing application at shared storage system 140. As yet another example, it might be determined that file “D” 250 was created by a editing file “A” 210, and it might further be determined that this editing comprises removing a slide from the presentation contained in file “D” 250. (Refer to the related application for further discussion of events.)

As has been demonstrated, an embodiment of the present invention assists a user by discovering related files and by providing annotations and/or difference information. As noted earlier, the annotations and differences may be provided for a particular one of the files, or for more than one of the files. This information may be displayed visually or provided in another way.

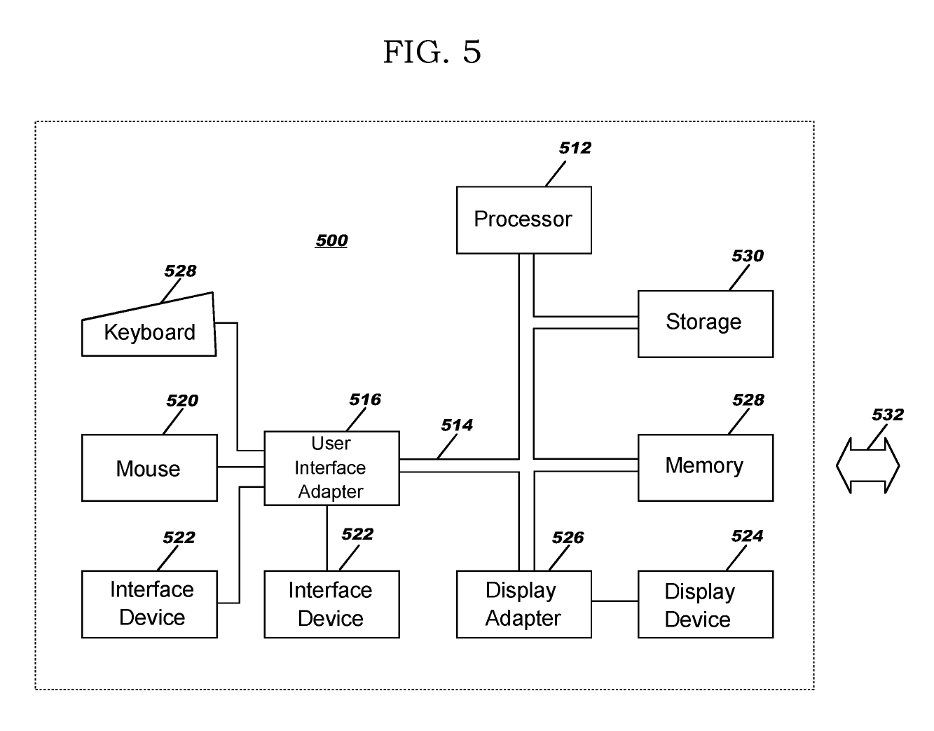

Referring now to FIG. 5, a data processing system 500 suitable for storing and/or executing program code includes at least one processor 512 coupled directly or indirectly to memory elements through a system bus 514. The memory elements can include local memory 528 employed during actual execution of the program code, bulk storage 530, and cache memories (not shown) which provide temporary storage of at least some program code in order to reduce the number of times code must be retrieved from bulk storage during execution.

Input/output (“I/O”) devices (including but not limited to keyboards 518, displays 524, pointing devices 520, other interface devices 522, etc.) can be coupled to the system either directly or through intervening I/O controllers or adapters (516, 526).

Network adapters may also be coupled to the system to enable the data processing system to become coupled to other data processing systems or remote printers or storage devices through intervening private or public networks (as shown generally at 532). Modems, cable modem attachments, wireless adapters, and Ethernet cards are just a few of the currently-available types of network adapters.

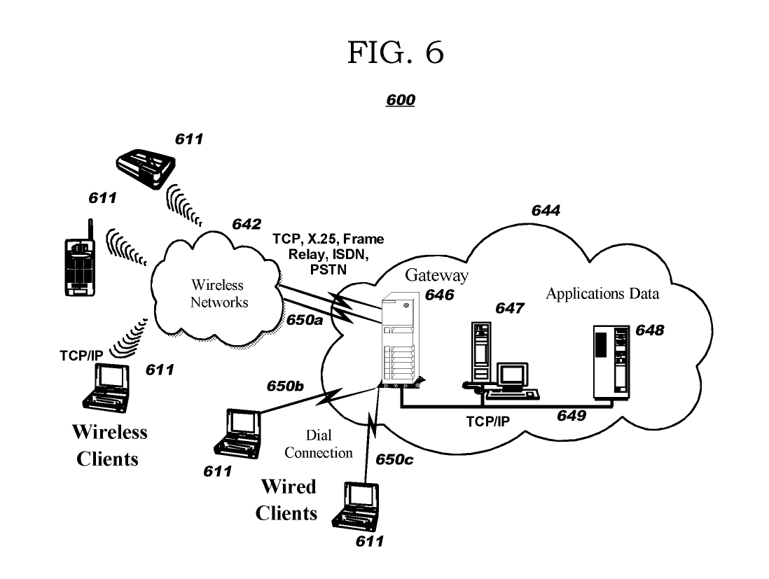

FIG. 6 illustrates a data processing network environment 600 in which the present invention may be practiced. The data processing network 600 may include a plurality of individual networks, such as wireless network 642 and wired network 644. A plurality of wireless devices 610 may communicate over wireless network 642, and a plurality of wired devices, shown in the figure (by way of illustration) as workstations 611, may communicate over network 644. Additionally, as those skilled in the art will appreciate, one or more local area networks (“LANs”) may be included (not shown), where a LAN may comprise a plurality of devices coupled to a host processor.

Still referring to FIG. 6, the networks 642 and 644 may also include mainframe computers or servers, such as a gateway computer 646 or application server 647 (which may access a data repository 648). A gateway computer 646 serves as a point of entry into each network, such as network 644. The gateway 646 may be preferably coupled to another network 642 by means of a communications link 650a. The gateway 646 may also be directly coupled to one or more workstations 611 using a communications link 650b, 650c, and/or may be indirectly coupled to such devices. The gateway computer 646 may be implemented utilizing an Enterprise Systems Architecture/390® computer available from IBM. Depending on the application, a midrange computer, such as an iSeries®, System i™, and so forth may be employed. (“Enterprise Systems Architecture/390” and “iSeries” are registered trademarks, and “System i” is a trademark, of IBM in the United States, other countries, or both.)

The gateway computer 646 may also be coupled 649 to a storage device (such as data repository 648).

Those skilled in the art will appreciate that the gateway computer 646 may be located a great geographic distance from the network 642, and similarly, the workstations 611 may be located some distance from the networks 642 and 644, respectively. For example, the network 642 may be located in California, while the gateway 646 may be located in Texas, and one or more of the workstations 611 may be located in Florida. The workstations 611 may connect to the wireless network 642 using a networking protocol such as the Transmission Control Protocol/Internet Protocol (“TCP/IP”) over a number of alternative connection media, such as cellular phone, radio frequency networks, satellite networks, etc. The wireless network 642 preferably connects to the gateway 646 using a network connection 650a such as TCP or User Datagram Protocol (“UDP”) over IP, X.25, Frame Relay, Integrated Services Digital Network (“ISDN”), Public Switched Telephone Network (“PSTN”), etc. The workstations 611 may connect directly to the gateway 646 using dial connections 650b or 650c. Further, the wireless network 642 and network 644 may connect to one or more other networks (not shown), in an analogous manner to that depicted in FIG. 6.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), DVD, an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages such as the “C” programming language or similar programming languages. The program code may execute as a stand-alone software package, and may execute partly on a user's computing device and partly on a remote computer. The remote computer may be connected to the user's computing device through any type of network, including a local area network (“LAN”), a wide area network (“WAN”), or through the Internet using an Internet Service Provider.

Aspects of the present invention are described above with reference to flow diagrams and/or block diagrams of methods, apparatus (systems), and computer program products according to embodiments of the invention. It will be understood that each flow or block of the flow diagrams and/or block diagrams, and combinations of flows or blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram flow or flows and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram flow or flows and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flow diagram flow or flows and/or block diagram block or blocks.

Flow diagrams and/or block diagrams presented in the figures herein illustrate the architecture, functionality, and operation of possible implementations of systems, methods, and computer program products according to various embodiments of the present invention. In this regard, each flow or block in the flow diagrams or block diagrams may represent a module, segment, or portion of code, which comprises one or more executable instructions for implementing the specified logical function(s). It should also be noted that, in some alternative implementations, the functions noted in the flows and/or blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flow of the flow diagrams, and combinations of blocks in the block diagrams and/or flows in the flow diagrams, may be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of discovering related files, comprising:
receiving an identification of a selected file;
receiving an identification of user-selected criteria for determining relatedness;
discovering at least one file that is related to the selected file according to the identified criteria; and
providing an identification of each of the discovered at least one file.

2. The method according to claim 1, wherein the criteria is based on at least one of: file name of the selected file; modification time of the selected file; file size of the selected file; and a value computed by performing a similarity hash on contents of the selected file.

3. The method according to claim 1, wherein the criteria is based on at least one event that pertains to the selected file.

4. The method according to claim 3, wherein the criteria is applied to event information obtained by consulting at least one of event logs and event-related information stored within the selected file and each discovered file.

5. The method according to claim 1, wherein the user-selected criteria is specific to a type of the selected file.

6. The method according to claim 1, wherein the providing comprises displaying the identification of each discovered file on a user interface.

7. The method according to claim 1, wherein the providing further comprises providing difference information indicating, for at least one of the discovered at least one file, how the discovered file differs from the selected file.

8. The method according to claim 1, wherein the providing further comprises providing, for at least one of the selected file and at least one of the at least one discovered file, at least one informative annotation.

9. The method according to claim 8, wherein the information annotation comprises at least one of: a location of the file; an identification of an event pertaining to the file; and a selectable link from which additional detail is available for the file.

10. A system for discovering related files, comprising:
a computer comprising a processor; and
instructions which are executable, using the processor, to implement functions comprising:
receiving an identification of a selected file;
receiving an identification of user-selected criteria for determining relatedness;
discovering at least one file that is related to the selected file according to the identified criteria; and
providing an identification of each of the discovered at least one file.

11. The system according to claim 10, wherein:
the functions further comprise receiving an identification of event information pertaining to the selected file; and
the discovering comprises discovering at least one file that is related to the selected file according to the identified criteria and the identified event information.

12. The system according to claim 10, wherein:
the functions further comprise:
receiving an identification of event information pertaining to the selected file; and
gathering event information pertaining to at least one of the at least one discovered file;
the providing comprises providing an identification of each of the discovered at least one file and at least one of the identification of event information pertaining to the selected file and the gathered event information.

13. The system according to claim 10, wherein the identification of user-selected criteria is received responsive to input from a user interface.

14. The system according to claim 10, wherein the identification of user-selected criteria is received from a configuration file.

15. A computer program product for discovering related files, the computer program product comprising:
a computer readable storage medium having computer readable program code embodied therein, the computer readable program code configured for:
receiving an identification of a selected file;
receiving an identification of user-selected criteria for determining relatedness;
discovering at least one file that is related to the selected file according to the identified criteria; and
providing an identification of each of the discovered at least one file.

16. The computer program product according to claim 15, wherein the providing comprises displaying the identification of each discovered file on a user interface.

17. The computer program product according to claim 15, wherein the providing further comprises providing difference information indicating, for at least one of the discovered at least one file, how the discovered file differs from the selected file.

18. The computer program product according to claim 15, wherein the providing further comprises providing, for at least one of the selected file and at least one of the at least one discovered file, at least one informative annotation.

19. The computer program product according to claim 18, wherein the information annotation comprises at least one of: a location of the file; an identification of an event pertaining to the file; and a selectable link from which additional detail is available for the file.
